(19) United States
(12) Patent Application Publication
(10) Pub. No.: US 2010/0215974 A1
(43) Pub. Date: Aug. 26, 2010

(54) ELECTROLESS PROCESS FOR DEPOSITING A METAL ON A NON-CATALYTIC SUBSTRATE

(75) Inventors: Roland Anthony Tacken, Geldrop (NL); Renatus Marius De Zwart, Eindhoven (NL); Arjan Hovestad, PK's-Hertogenbosch (NL)

Correspondence Address: RENNER OTTO BOISSELLE & SKLAR, LLP, 1621 EUCLID AVENUE, NINETEENTH FLOOR, CLEVELAND, OH, 44115, US

(73) Assignee: NEDERLANDSE ORGANISATIE

(21) Appl. No.: 12/675,985

(22) PCT Filed: Sep. 5, 2008
(86) PCT No.: PCT/NL2008/050583

§ 371 Date: May 4, 2010

(30) Foreign Application Priority Data
Sep. 5, 2007 (EP) 07115731.7

(51) Int. Cl. B32B 15/04; B05D 3/02; B05D 1/18

(52) U.S. Cl. 428/457; 427/372.2

(57) ABSTRACT

The invention provides an electroless process for depositing a metal on an essentially catalyst-free substrate, which process comprises the steps of: (a)providing an essentially catalyst-free substrate; and (b) exposing said essentially catalyst-free substrate to an electroless solution to deposit the metal on the substrate, which solution comprises metal ions and a reducing agent for reducing the metal ions into the metal, whereby at least the surface of the substrate has a temperature or is heated to a temperature (T1) which is higher than the temperature (T2) of the solution.

The present invention relates to an electroless process for depositing a metal on an essentially catalyst-free substrate, an electric circuit comprising a substrate obtained with said process, and an electric device comprising such an electric circuit.

Various processes are known to deposit a metal on an object such as for instance a plastic, ceramic or metallic substrate. Such processes include electroplating processes wherein use is made of an electrical current to deposit a metal layer on an electrically conductive object, e.g. substrate. Both the object and the metal component to be deposited on the object are placed in a solution, whereby the object to be plated functions as the cathode and the metal component functions as the anode. The solution contains one or more salts of the corresponding metal together with other ions that allow electricity to flow through the solution. Electricity is supplied to the object to be coated causing the metal ions in the solution to be reduced to the metal which deposits on the object, whereas the metal component dissolves and replenishes its metal ions in the solution. Such an electroplating process is used for instance to improve various properties of the object to be coated, e.g. wear resistance and corrosion protection.

Electroless processes constitute another category of processes in which a metal can be deposited on a substrate. Electroless processes depend on the catalytic reduction of metal ions in an aqueous solution which contains a reducing agent which establishes that the metal ions will be reduced to the corresponding metal and deposit on the object to be coated without the use of an external electric current. The deposition of the metal concerned takes place on a catalytic substrate. A few metals have the ability to initiate and catalyse the electroless deposition of a metal on a substrate, e.g. Pd, Ag, Au, Pt, Cu and Ni. Substrates that need to be metallised but that do not consist or contain one of these catalytic metals, are typically made catalytic by adsorption of catalytic colloids to the surface of the substrate. Most often, this is done by absorption of palladium colloids on the surface of the substrate on which the desired metal is to be deposited. In addition to the substrate, the metal to be deposited on the substrate should also be catalytic to the reduction reaction, rendering the process autocatalytic as such. For a general description on electroless plating processes reference can, for instance, be made to Electroless Plating Fundamentals & Applications, edited by Glenn O. Mallory and Juan B. Hajdu, New York (1990). When compared with electroplating processes, electroless plating processes have general the advantage that no electrical power is required and that improved metal coatings can be established in terms of uniformity and stress of deposits.

Object of the present invention is to provide an electroless plating process in which no metal catalyst is required to initiate and catalyse the deposition of a desired metal on the surface of a substrate.

Surprisingly, it has now been found that this can be established when the temperature of the surface on which the metal needs to be deposited is higher than the temperature of the solution containing the metal ions and the reducing agent.

Accordingly, the present invention relates to an electroless process for depositing a metal or alloy thereof on an essentially catalyst-free substrate, which process comprises the steps of:
(a) providing an essentially catalyst-free substrate; and
(b) exposing said essentially catalyst-free substrate to an electroless solution to deposit the metal on the substrate, which solution comprises metal ions and a reducing agent for reducing the metal ions into the metal, whereby at least the surface of the substrate has a temperature or is heated to a temperature (T1) which is higher than the temperature (T2) of the solution.

The process according to the present invention has the advantages that no metal catalyst needs to be applied on the substrate surface to initiate and catalyse the metallisation process. Moreover, metal deposition is rapid because of the high temperatures applied. Hence, in the context of the present invention, an essentially catalyst-free substrate is a substrate on which no metal catalyst has been applied to initiate or catalyse the deposition of a metal or alloy thereof on its surface. Hence, the essentially catalyst-free substrate has not been seeded with catalyst. Apart from possible impurities, the essentially catalyst-free substrate does not comprise a catalyst. In a preferred embodiment, a catalyst-free substrate is used for the invention.

The substrate can be exposed to the electroless solution in various ways. For instance, the electroless solution can be brought into contact with the essentially catalyst-free substrate by means of an inkjet printing process, the substrate can be immersed in the electroless solution or, in case the substrate has the form of a moulded product, the electroless solution can be brought into contact with the moulded product in the mould in which the moulded product has been or is being produced.

Preferably, the essentially catalyst-free substrate is immersed in the electroless solution comprising the metal ions and the reducing agent.

Suitably, the metal or alloy to be deposited on the essentially catalyst-free substrate is selected from the group consisting of nickel, copper, gold, silver, tin, or any alloy thereof, and nickel-boron and nickel-phosphorous.

Preferably, the metal to be deposited on the essentially catalyst-free substrate is copper. Preferably, the alloy to be deposited on the essentially catalyst-free substrate is nickel-phosphorous or nickel-boron alloy.

In accordance with the present invention, at least the surface of the substrate has a temperature or is heated to a temperature (T1) which is higher than the temperature (T2) of the solution.

Suitably, the temperature T1 is in the range of from 50-200° C. Preferably, the temperature T1 is in the range of from 80-180° C., more preferably in the range of from 70-140° C.

Suitably, the temperature T2 is in the range of from 15-90° C. Preferably, the temperature T2 is in the range of from 15-60° C. More preferably in the range of from 15-25° C. In other words, T2 can suitably be the ambient temperature.

The essentially catalyst-free substrate to be used in accordance with the present invention can suitably comprise liquid crystalline polymer (LCP), polyamide (PA6, PA6,6, PA4,6, or PA12), poly(phenylene sulphide) (PPS), polyetherimide (PEI), polybutylene terephthalate (PBT), syndiotactic polystyrene (SPS), polyethylene-terephthalate (PET), polycarbonate (PC), acrylonitrile-butadiene-styrene (ABS), polycarbonate/ABS, polypropylene (PP) and polyethylene (PE), thermohardening materials such as an epoxy or polyester compound, or ceramic materials.

In an embodiment of the process of the invention the concentration of both the metal ions and reducing agent present in the electroless solution is chosen as high as possibly, i.e. close to maximum solubility, while maintaining room temperature stability.

The reducing agent to be used in accordance with the present invention can suitably selected from the group consisting of formaldehyde, dimehtylaminoborane, hypophosphite, sodium borohydride and hydrazine.

The electroless solution to be used in the present process can suitably further comprise a complexing agent. Said complexing agent can suitably be selected from the group consisting of acetate, propionate, succinate, hydroxyacetate, ammonia, hydroxypropionate, glycolic acid, aminoacetate, ethylenediamine, aminopropionate, malonate, pyrophosphate, malate, citrate, gluconate, tartate, EDTA, propionitrile, tetraethylenetetraamine, 1,5,8,12 tetraazaundecane, 1,4,8,12 tetraazacyclopentadecane, and 1,4,8,11 tetraazandecane.

The electroless solution to be used in accordance with the invention can further suitably comprise a buffering agent. Said buffering agent can suitably be selected from the group consisting of acetic acid, propionic acid, succinic acid, glutaric acid, adipic acid, organic amines, and carboxylic acids.

The electroless solution to be used in the present process can further suitably comprise a stabiliser. Said stabiliser may suitably comprise heavy metal ions, an organic or inorganic sulphur, selenium or tellur-containing compound.

In a particular embodiment, the present process is carried out in a mould, and whereby the substrate is formed in the mould by means of a three-dimensional injection moulding process.

In addition, the present invention also relates to an electric circuit which comprises a substrate as obtained with the present process.

The present invention also relates to a device comprising a substrate as obtained in accordance with the present invention.

Suitable devices include, but are not limited to, antenna structures, interconnection elements sensors, and actuators.

Preferably, the device according to the present invention is an electric device which comprises an electric circuit in accordance with the present invention.

### EXAMPLE I

An electroless plating solution was used which contained copper sulphate in an amount of 0.06 mol/l. The electroless solution was buffered using triethanolamine in a concentration of 0.2 mol/l. The pH of the electroless solution was 9.0. The electroless solution so obtained was then is stabilised using 1,4,8,11 tetraazaundecane as a complexing agent in an amount of 0.05 mol/l. The electroless solution further contained as the reducing agent dimethylaminoborane in an amount of 0.06 mol/l. The electroless solution having an ambient temperature was then brought in contact with a polyamide substrate (type Stanyl TE200F6, supplier DSM) having on the surface a temperature of 130° C. A closed metallised electrically conducting surface was obtained within 20 seconds.

### EXAMPLE II

An electroless plating solution was used which contained copper sulphate in an amount of 0.08 mol/l. The electroless solution was buffered using triethanolamine in a concentration of 0.2 mol/l. The pH of the electroless solution was 9.0. The electroless solution so obtained was then stabilised using 1,4,8,11 tetraazaundecane as a complexing agent in an amount of 0.08 mol/l. The electroless solution further contained as the reducing agent dimethylaminoborane in an amount of 0.06 mol/l. The electroless solution having an ambient temperature was then brought into contact with a liquid crystalline polymer substrate (type Vectra 820i, supplier Ticona) having on the surface a temperature of 90° C. Prior to this step, the substrate had been etched in a hot (80° C.) alkaline solution for activation. A closed metallised electrically conducting surface was obtained within 20 seconds.

1. An electroless process for depositing a metal on an essentially catalyst-free substrate, which process comprises the steps of:
(a) providing an essentially catalyst-free substrate; and
(b) exposing said essentially catalyst-free substrate to an electroless solution to deposit the metal on the substrate, which solution comprises metal ions and a reducing agent for reducing the metal ions into the metal, whereby at least the surface of the substrate has a temperature or is heated to a temperature (T1) which is higher than the temperature (T2) of the solution.

2. A process according to claim 1, wherein the substrate is immersed in the solution.

3. A process according to claim 1, wherein the metal is selected from the group consisting of copper, nickel, gold, silver, tin, or any alloy thereof, and nickel-boron and nickel-phosphorous.

4. A process according to claim 3, wherein the metal is copper.

5. A process according to claim 3, wherein the alloy is nickel-phosphorous or nickel-boron.

6. A process according to claim 1, wherein the temperature T1 is in the range of from 50-200° C.

7. A process according to claim 6, wherein the temperature T1 is in the range of from 70-140° C.

8. A process according to claim 1, wherein the temperature T2 is in the range of from 15-90° C.

9. A process according to claim 8, wherein the temperature T2 is in the range of from 15-25° C.

10. A process according to claim 1, wherein the substrate comprises liquid crystalline polymer (LCP), polyimide (PA6, PA6,6, PA4,6, or PA12), poly(phenylene sulphide) (PPS), polyetherimide (PEI) , polybutylene terephthalate (PBT), syndiotactic polystyrene (SPS), polyethylene terephthalate (PET), polycarbonate (PC), acrylonitrile-butadiene-styrene (ABS), polycarbonate/ABS, polypropylene (PP), and polyethylene (PE), thermohardening materials such as an epoxy or polyester compound, or ceramic materials.

11. A process according to claim 1, wherein the reducing agent is selected from the group consisting of formaldehyde, dimethylaminoborane, hypophosphite, sodium borohydride and hydrazine.

12. A process according to claim 1, wherein the solution further comprises a complexing agent.

13. A process according to claim 12, wherein the complexing agent is selected from the group consisting of acetate, propionate, succinate, hydroxyacetate, ammonia, hydroxypropionate, glycolic acid, aminoacetate, ethylenediamine, aminopropionate, malonate, pyrophosphate, malate, citrate, gluconate, tartate, EDTA, propionitrile, tetraethylenetetraamine, 1,5,8,12 tetraazaundecane, 1,4,8,12 tetraazacyclopentadecane, and 1,4,8,11 tetraazandecane.

14. A process according to claim 1, wherein the solution further comprises a buffering agent.

15. A process according to claim 14, wherein the buffering agent is selected from the group consisting of acetic acid, propionic acid, succinic acid, glutaric acid, adipic acid, organic amines, and carboxylic acids.

16. A process according to claim 1, wherein the solution further comprises a stabiliser.

17. A process according to claim 16, wherein the stabiliser comprises heavy metal ions, an organic or inorganic sulphur, selenium or tellur-containing compound.

18. A process according to claim 1, which is carried out in a mould, and whereby the substrate is formed in the mould by means of a three-dimensional injection moulding process.

19. An electric circuit which comprises a substrate as obtained according to claim 1.

20. An electric device which comprises an electric circuit according to claim 19.
